(19) United States
(12) Patent Application Publication
(10) Pub. No.: US 2005/0281923 A1
(43) Pub. Date: Dec. 22, 2005

(54) Method of manufacturing packaged dough products

(76) Inventors: Chad M. Kubat, Woodbury, MN (US); Thomas C. Hoese, Hopkins, MN (US)

Correspondence Address: GENERAL MILLS, INC., P.O. BOX 1113, MINNEAPOLIS, MN, 55440, US

(21) Appl. No.: 11/145,415

(22) Filed: Jun. 3, 2005

Related U.S. Application Data
(60) Provisional application No. 60/576,844, filed on Jun. 3, 2004.

(51) Int. Cl. A23G 3/00

(52) U.S. Cl. 426/128

(57) ABSTRACT

Methods of manufacturing packaged dough products are provided. A heat stable film is used as a processing aid and as at least a portion of a final package for the dough product. Since the heat stable film is at least a portion of the final package, the dough product can be subjected to a cooking or reheating (e.g., by conventional or microwave oven) cycle within the package, thereby also providing enhanced convenience to an end user of the dough product.

### REFERENCE TO RELATED APPLICATIONS

This application claims the benefit of priority under 35 U.S.C. § 119(e)(1) of a provisional patent application Ser. No. 60/576,844, filed Jun. 3, 2004, which is incorporated herein by reference in its entirety.

### FIELD OF THE INVENTION

The invention relates to a method of preparing packaged dough products. In particular, packaged dough products that include a heat stable film as both a processing aid and a component of a package for the dough product, are provided.

### BACKGROUND

In recent years, a trend in food product development has been toward providing products suitable for both quick preparation and convenient consumption, e.g., “on the go.” Even though many new products meeting these needs have been introduced commercially in recent years, there remains a need for a greater variety of healthful yet convenient products.

In the food industry, differences in profit margins of pennies may determine whether or not a product is ever mass produced. The ability to commercially produce and sell any specific food product often depends on whether the product can be produced with economies of scale or other efficiencies. For example, a decision to invest in a new piece of manufacturing equipment may be simplified if the equipment can be used to produce more than one product. Similarly, expenses relating to packaging a product can be more easily accepted, if expenses can be spread among more than one product or facility. Manufacturing speed is also a factor, and any efficiencies that can be gained in line speeds, or reduction in lost time for changeover, repair, or cleaning processes, can have a tremendous impact on the profit margin associated with any given product.

On the other hand, many food products are more difficult or complex to manufacture than might be imagined. Dough products, in particular, and filled dough products even more so, can present handling and processing challenges that can be difficult to overcome while achieving the flexibility and processing speeds desirable for economical manufacturing. Dough products, whether filled or unfilled, tend to be sticky at some point during their manufacture, which can cause them to be difficult to handle or require equipment cleaning steps once handled. If fillings or toppings are included in a product, the steps of applying or inserting a filling or topping in a way that minimizes waste or mess can present additional challenges. Preparation of leavened dough products may also require the dough to increase in volume upon expansion during a proofing, leavening, or rising step, or when baked. Such expansion will affect oven or proof box space, time, and possibly final packaging size requirements.

It would be desirable to provide new ways to achieve efficiencies in the manufacture of dough products, including filled dough products. Time savings by eliminating steps previously required, such as cleaning steps, or by combining two steps into one, would be advantageous. Cost savings would additionally be appreciated by the manufacturer, as may be provided by a reduction in required materials or equipment costs.

### SUMMARY

Methods of manufacturing a packaged dough product are provided. An exemplary method of the invention uses a heat stable film during preparation of a dough product, e.g., to assist in the sizing, portioning, movement, coating, cooking, or other manipulation or processing of a dough composition. The same heat stable film is then incorporated into a package for the dough composition for later sale or distribution.

Exemplary methods of the invention can provide efficiency by using the heat stable film for multiple purposes, including as a processing aid and as a component of a package for the dough product. Exemplary methods can provide significant time saving, e.g., by increasing the ease of handling of a dough product during preparation, and thus, the speed with which the dough product may be processed. Further time savings may be provided by the potential elimination of equipment cleaning steps that may otherwise be required. For example, according to methods of the invention, use of a heat stable film as described may eliminate steps of cleaning processing equipment by providing a barrier between the dough composition and equipment used in processing. Manufacturing flexibility can also be increased in that a manufacturing line may readily and easily be used to produce more than one type of packaged dough product without necessarily shutting down the line for cleaning.

In accordance with certain embodiments of the invention, methods can include supplying a dough product and a heat stable film operatively disposed relative to another. In specific embodiments, a heat stable film is provided among a series of steps used to prepare a dough product, and a dough composition is placed against or onto the heat stable film. For example, a heat stable film may be introduced to a moving and continuous dough processing line, and a dough composition can be extruded, co-extruded, dropped, rolled, manually or automatically placed, or introduced into association with the heat stable film by any other method. The heat stable film may be supplied from a continuous roll of heat stable film, to a moving dough processing line, and may be cut, folded, or otherwise manipulated as desired. Alternately, a heat stable film may be extruded or co-extruded on site, optionally in proximity to a step of placing a dough composition in contact with the heat stable film.

Following placement of a dough product in contact with the heat stable film, any one or more food processing steps can then be performed on the dough product and heat stable film, such as one or more of sizing, portioning, collating, moving, frosting, topping, patterning, cutting, crimping, cooking, freezing, storing, or exposing the dough and heat stable film to conditions that will allow the dough to proof. Processing of the dough composition while the dough composition contacts the heat stable film may be relatively efficient, due to the presence of the heat stable film, compared to like methods of processing like dough compositions without the use of a heat stable film as described. The heat stable film is then used to form at least a portion of a package about the dough composition, to provide a packaged dough product in accordance with the present invention.

In certain embodiments, a method may include a step of subjecting the packaged dough composition to a cooking cycle to provide a baked packaged dough product. The cooking step may be performed by the manufacturer of the dough product before or after a manipulation or packaging step, or may be performed by an end-consumer of the dough product after the packaging step. Once packaged, the dough product (baked or raw) may also be subjected to refrigerated or freezer temperatures, optionally refrigerated or frozen storage, so that the dough product may be conveniently and easily transported, stored, cooked (e.g., baked), or reheated (e.g., in a conventional or microwave oven) within the package.

As used herein, the term “final package” is to be given a meaning consistent with normal meanings of the term in the context of food and dough products, and is to include a package that contains a dough product as that dough product is sold or distributed by a dough product manufacturer, converter, or processor, to any subsequent distributor or end user.

### BRIEF DESCRIPTION OF THE FIGURES

The accompanying figures, which are incorporated in and constitute a part of this application, illustrate several aspects of the invention and, together with the description of the embodiments, serve to explain the principles of the invention. A brief description of the figures is as follows:

FIG. 1 is a schematic representation of an embodiment of the invention where a heat stable film is used as a processing aid for extruded dough products.

FIG. 2 is a schematic representation of another embodiment of the invention where a heat stable film is used in a dough processing operation.

FIG. 3 is a schematic representation of another embodiment of the invention where a heat stable film is used in a dough processing operation.

FIG. 4 is a schematic representation of another embodiment of the invention where a heat stable film is used in a dough processing operation.

FIG. 5 is a schematic representation of another embodiment of the invention where a heat stable film is used in a dough processing operation.

### DETAILED DESCRIPTION

Embodiments of the invention described herein are not intended to be exhaustive or to limit the invention to the particular embodiments disclosed in the following detailed description. Rather, the embodiments are described so that others skilled in the relevant arts can understand the principles and practices of the present invention.

The invention relates to methods of providing a packaged dough product, and to packaged dough products. A heat stable film is used as a processing aid in preparing a packaged dough composition, and also functions as at least a portion of a package for the dough composition. The invention may provide cost savings by, for example, using a single material for dual functions (processing and packaging), by increasing line speeds, or reducing necessary cleaning steps, etc.

According to specific embodiments, a heat stable film is used during processing of a dough product, for example as a support material in the form of a sheet onto or against which a dough piece or composition is placed. The heat stable film also may function as any one or more of: a portion of a package for the dough composition; a cooking container in which the dough composition can be heated or cooked; or a container from which the dough composition can be served or eaten. Further, if desired, the heat stable film can include a variety of markings or indicia for distribution, sales, and end use. In such embodiments of the invention, the heat stable film reduces cost and increases efficiency of manufacturing, for the producer. Subsequently, an end user of the dough product may appreciate the convenience of a package that can function both as a cooking or heating container, and an eat-in wrapper.

Generally speaking, the method includes supplying a dough product and a heat stable film, and operatively disposing the dough composition and the heat stable film relative to each other, for purposes as described herein. This can include placing the dough composition against or onto the film during any stage of processing. The dough composition is then subjected to one or more processing steps, the performance of which can be easier, more efficient, or more convenient, because of the presence of the heat stable film. The heat stable film is eventually used to form at least a portion of a package for the dough composition, such as a final package used to contain the dough composition for distribution and sale. As such, the heat stable film acts both as a processing aid and a portion of a package for the dough composition.

To assist in processing, the heat stable film can act as a barrier, or interface, between the dough composition and at least one component of manufacturing equipment used to process the dough composition, so that direct contact of the dough composition with the manufacturing equipment can be reduced or eliminated. Conventionally, equipment surfaces that may contact dough during processing, e.g., surfaces of conveyor belts, cutters or crimpers, trays, pans, lappers, collators, carts, and the like, require periodic cleaning because doughs tend to be sticky, and as a result leave residue on equipment used to contact or manipulate them. Alternately, equipment surfaces that contact dough during processing may be coated or covered with a material such as an oil, Teflon, parchment paper, or plastic film, to reduce or eliminate the need for cleaning. However, oiling may not always be effective enough to eliminate the need to clean entirely, and cleaning may be required to remove oil from the manufacturing equipment. Further, the additional expense of the oil, Teflon coated equipment, parchment paper, or film, may be prohibitive, or even negate any time savings provided by the use of any of these or similar materials. In contrast, the inventive method can use a heat stable film as a barrier between a dough composition and processing equipment.

A heat stable film, during any particular stage of processing, may be in any useful configuration, such as any size, shape, or form. For example, a heat stable film may be provided as any of: a substantially unsized sheet of film; a sized, sheeted portion of a film; a folded film, either sized or unsized; an envelope; a flexible pouch; a bag; a flexible tube; a rigid, non-rigid, or semi-rigid support for a single or multiple pieces of dough, e.g., in the form of a sheet; a tray or dish; etc., or any other suitable configuration that can be useful according to the present description. The film may be continuous or semi-continuous, or may be pre-cut, pre-folded, pre-sized, or otherwise pre-formed prior to introduction to a dough processing line. Suitable configurations, as described, can allow a reduced or minimal amount of contact between a dough composition and equipment used to process the dough composition, which can reduce or eliminated the need for cleaning of the equipment. Problems of dough sticking to the equipment during processing may also be reduced or eliminated.

Whatever configuration is used, the heat stable film may be provided at any convenient stage of processing a dough product, such as relative to a piece of equipment that may come into contact with a dough composition during manufacture. For example, the heat stable film may be provided relative to a conveying surface, e.g., conveyor belt, or any other apparatus used to handle or move a dough composition during manufacture. Specific examples of equipment and surfaces include trays, pans, carts, etc., or any apparatus used to manipulate the dough, including, but not limited to, lappers, sheeters, cutters, ovens, freezers, crimpers, extruders, collators, and the like.

A heat stable film for use as described herein, may be provided in any useful manner, including simple manual or mechanically assisted placement from a supply such as a roll; a stack of sized sheets of heat stable film, etc.; or directly as part of the manufacturing process, e.g., by extrusion, coating, or casting techniques.

A dough composition may be placed relative to the heat stable film using any useful (e.g., conventional) method for handling dough compositions, whether mechanically assisted or manual, e.g., such as by placing, sheeting, extruding, rolling, dropping, pulling, pumping, and the like. In certain embodiments of the invention, a dough composition and heat stable film may be placed into a processing line at the same location, or at close locations along a processing line. For example, a heat stable film may be introduced to a line from a continuous roll, at a conveyor station. Shortly downstream from the introduction of the heat stable film, a dough composition may be placed (e.g., extruded, mechanically placed, or hand placed) onto the moving heat stable film, continuously or intermittently, e.g., may be extruded to provide a dough product extrudate of indefinite length or pieces of defined size, respectively.

Once the dough composition has been operatively disposed relative to the heat stable film, the dough composition may be subjected to at least one processing step, according to any manufacturing scheme. Because the heat stable film can act to minimize contact with processing equipment, thereby reducing or eliminating sticking of the dough composition to the equipment, processing may be relatively efficient. Also, cleaning of the equipment otherwise necessary following processing may be less extensive or even eliminated.

Many, if not all, steps of processing a dough from its ingredients to a saleable product, require contact between a dough composition and processing equipment. Examples of typical processing steps include sheeting, proofing, folding, cutting, crimping, portioning, baking, filling, frosting, depositing, patterning, cooling, freezing, collating, grouping or otherwise manipulating, moving, transporting, and indeed simply conveying. Any such steps may be made more efficient by use of a heat stable film as a processing aid, as described.

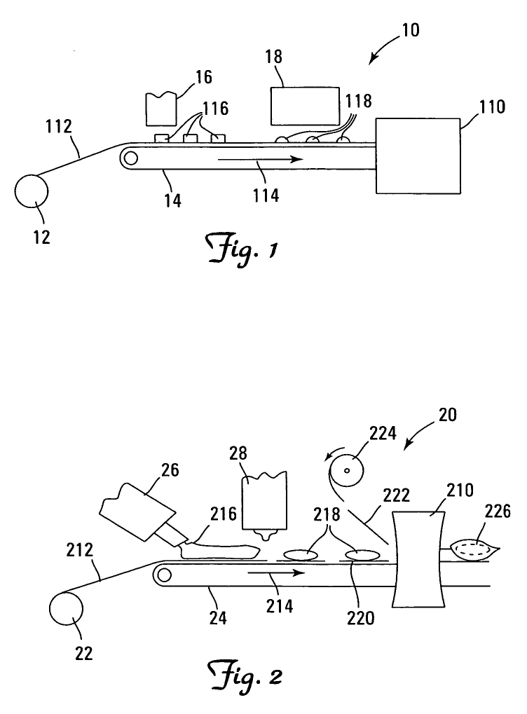

For example, many processes for preparing a dough product involve depositing dough or a piece of dough onto a conveyor belt that moves the dough throughout several other processes as may be carried out manually or by use of other automated equipment. According to embodiments of the invention, a heat stable film may be placed between the dough and the conveyor belt, or other apparatus used to assist in the movement of the dough through the process. As a result, sticking of the dough to the conveyor belt that may otherwise occur may be reduced or eliminated, reducing or eliminating the need to clean the conveyor belt once manufacturing is complete, or a change in product is desired. An exemplary illustration of this embodiment of the present invention is shown in FIG. 1.

As shown in FIG. 1, dough processing system 10 includes a supply of heat stable film 12, a conveyor belt 14, dough extruder 16, shaping station 18 and thermal station 110. Supply 12 is operatively disposed relative to conveyor belt 14 so that movement of conveyor belt 14 and heat stable film 112 are substantially the same. As mentioned above, heat stable film need not be so supplied, but rather could be provided either directly and continuously from a manufacturing system, such as an extrusion system, etc., or could be provided in the form of pre-cut, sized, and shaped pieces. As conveyor belt 14 and heat stable film 112 move in the direction of arrow 114, dough extruder 16 extrudes dough pieces 116 onto heat stable film 112 as film 112 is carried by conveyor belt 14. Dough pieces 116 are then conveyed to shaping station 18, wherein the dough pieces may be manipulated in any fashion to provide a desired shape or pattern. Shaped dough pieces 118 may then be conveyed to thermal station 110, wherein the dough pieces 118 may be proofed, baked, cooled, frozen, or otherwise further processed as desired.

According to alternate embodiments of methods of the invention, a dough product may be extruded in the form of a continuous dough product extrudate, which extrudate can contact a heat stable film during processing. In such embodiments, the heat stable film may assist in any step of further processing the continuous extrudate, such as any one or more of cutting, crimping, shaping, filling, folding, portioning, etc., the extrudate into dough pieces, e.g., multiple portion groups or individual dough portions. As a single more specific example, the dough composition may be extruded as a substantially continuous dough extrudate onto a portion of a substantially continuous sheet of heat stable film sized to be capable of longitudinally surrounding the dough product extrudate. Prior to portioning, shaping, or sizing, the dough into the desired portions, the heat stable film may be caused to surround the length of the dough product extrudate by any of the many known, conventional methods of folding a film about a dough composition. As a result, when a cutting or crimping apparatus (or any other apparatus) operates on the dough extrudate, the heat stable film provides a barrier between the apparatus and the dough composition. Sticking that may otherwise occur between the apparatus and the dough composition is reduced or eliminated. Likewise, any residue that may otherwise be left on the apparatus from contacting the dough composition may be reduced, thereby reducing the need to clean the apparatus between operations involving different dough compositions.

Such embodiments of the inventive methods, e.g., wherein the heat stable film can be caused to substantially surround the dough composition (e.g., extrudate) during processing or assembly, may be applied in particular to filled dough products, because filled dough products can tend to be particularly sticky and can also tend to experience filling leakage when subjected to processes that apply pressure to the filled dough compositions, e.g., processes to cut, crimp, pattern, shape, etc. Because the heat stable film can substantially surround a filled dough composition, the heat stable film can minimize contact of the filled dough composition with both the supporting apparatus, e.g., conveyor belt, pan, tray, etc., and the pressure applying apparatus. Additionally, any filling that may leak from the dough composition during processing may be substantially contained by the heat stable film. The heat stable film can function to reduce sticking that may otherwise occur between the dough product and either piece of equipment, and can reduce or eliminate the need for cleaning that may otherwise be necessary after the process.

In alternate embodiments of the inventive methods, a dough composition may be provided in operative disposition with the heat stable film, after the dough composition has been processed to form an already-portioned state, e.g., a dough composition can be formed to a desired shape and size (a “dough piece”). Accordingly, a dough piece or a series of dough pieces may be deposited onto a conveyor belt or other movement-facilitating piece of equipment, on top of a continuous or sized portion of heat stable film. The heat stable film may then provide assistance in any subsequent processing step that involves individual pieces of the dough, such as applying other materials or ingredients to the dough piece. As a specific example, a heat stable film can be used to support or carry a dough piece during a step of applying topping to the dough piece, whereby the heat stable film provides a barrier between the dough product (with the applied topping), and the conveying apparatus.

According to still alternate embodiments, a heat stable film can be caused to substantially surround one or more previously-sized dough pieces. The heat stable film may act as a processing aid by assisting in the movement of the dough pieces into desired groupings or configurations for packaging, e.g., by providing a barrier or interface between the dough pieces and the equipment used to move the dough pieces relative to the conveying apparatus, into any desired grouping or configuration.

One example of using a heat stable film to form at least a portion of a package (e.g., final package) for a dough product is shown in FIG. 2. Generally, FIG. 2 shows dough processing system 20 comprising a first supply of heat stable film 22, a conveyor belt 24, dough extruder 26, crimping and cutting station 28, sealing station 210, and a second supply of film 224, which film may or may not be heat stable, as desired. Supply 22 is operatively disposed relative to conveyor belt 24 so that movement of conveyor belt 24 and heat stable film 212 are substantially the same. As conveyor belt 24 and heat stable film 212 move in the direction of arrow 214, dough extruder 26 extrudes dough product extrudate 216 onto heat stable film 212 as film 212 is carried by conveyor belt 24. Dough product extrudate 216 is then conveyed to cutting and crimping station 28, wherein the dough product extrudate 216 is crimped and cut to provide portioned dough pieces 218. Optionally and as shown, cutting and crimping station 28 may also result in the portioning of heat stable film 212 into film pieces 220. Portioned dough pieces 218 and film pieces 220 are then conveyed to sealing station 210 wherein film pieces 222 are provided from second supply 224, sized to be capable, along with film pieces 220, of engaging with film pieces 220 to enclose portioned dough pieces 218 to provide packaged portioned dough products 226.

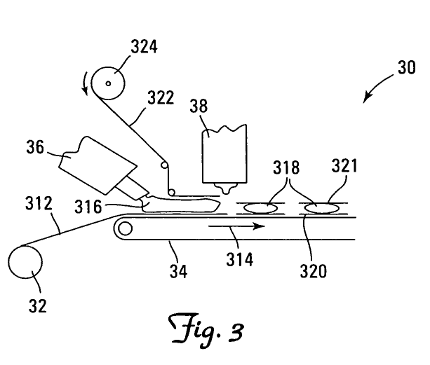

FIG. 3 also illustrates a specific embodiment of the invention. FIG. 3 shows dough processing system 30, including two supplies of heat stable films 32 and 324, a conveyor belt 34, dough extruder 36, and crimping and cutting station 38. Supplies 32 and 324 are operatively disposed relative to conveyor belt 34 so that movement of conveyor belt 34 and heat stable films 312 and 322 are substantially the same. As conveyor belt 34 and heat stable films 312 and 322 move in the direction of arrow 314, dough extruder 36 extrudes dough extrudate 316 onto heat stable film 312 as film 312 is carried by conveyor belt 34. Heat stable film 322 is placed on top of continuous dough extrudate 316. Dough extrudate 316, between films 312 and 322, is then conveyed to cutting and crimping station 38, wherein the dough extrudate 316 and films are together crimped and cut to provide portioned dough pieces 318. Portioned dough pieces 318, with film pieces 320 and 321, are then conveyed for further processing as desired, such as sealing of the film pieces to form a portion of a final package.

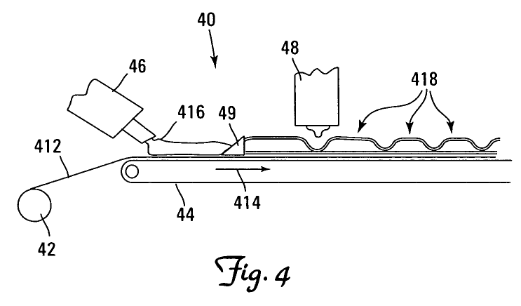

FIG. 4 illustrates another embodiment of a method of the invention. FIG. 4 shows a dough processing system 40, including supply 42 of heat stable film 412, conveyor belt 44, dough extruder 46, and station 48. Supply 42 is operatively disposed relative to conveyor belt 44 so that movement of conveyor belt 44 and heat stable film 412 are substantially the same. As conveyor belt 44 and heat stable film 412 move in the direction of arrow 414, dough extruder 46 extrudes dough extrudate 416 onto heat stable film 412 as film 412 is carried by conveyor belt 44. At folding station or “plow” 49, heat stable film 412 is folded to partially or completely surround or enclose dough extrudate 416. This can be done, for example, by applying extrudate 416 onto at a center position of the film 412 and lifting both edges of the film 412 to meet above the extrudate 416. Alternately, extrudate 416 may be continuously applied to at an off-center position of the film 412, and the film may be folded (e.g., approximately in half) such that a portion of film 412 covers extrudate 416, and edges of the film meet on one side of the processing line. Still other folding configurations are also possible and will be appreciated. Dough extrudate 416, within folded film 412, are then conveyed to station 48, wherein the dough extrudate 416 and folded film 412 are together crimped to provide portioned dough pieces 418. Station 48 can be a crimping or voiding station that uses a roller or other mechanism to produce film-to-film contact, of the folded film. Optionally, station 48 can also produce a seal at the contacting films. Portioned dough pieces 418, within folded film 412, are then conveyed for further processing as desired, such as a sealing of the folded film 412 at longitudinal and cross-sections, cutting at seals.

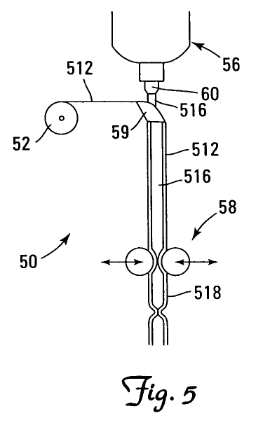

FIGS. 1 through 4 show processes that convey a dough product horizontally. In general, the invention can be applied to horizontal processes or non-horizontal processes, e.g., vertical processes. One example of a vertical process is shown in FIG. 5. FIG. 5 shows a dough processing system 50, including supply 52 of heat stable film 512, dough extruder 56, folding station or “plow” 59, and station 58. Supply 52 is operatively disposed relative to plow 59 and nozzle 60 of extruder 56, so that extrudate 516 meets film 512 at or near plow 59. Extruder 56 extrudes dough extrudate 516 onto heat stable film 512 just prior to film 512 being folded by plow 59. Folded heat stable film 512, with extrudate 516, moves vertically downward. Dough extrudate 516, within folded film 512, then passes between rollers of station 58, wherein the dough extrudate 516 and folded film 512 are together crimped to provide portioned dough pieces 518. Station 58 is shown as rollers that open and close on the moving extrudate and folded film. Station 58 can be a crimping or voiding station that uses a roller or other mechanism to produce film-to-film contact of the folded film. Optionally, station 58 can also produce a seal at the contacting films. Portioned dough pieces 518, within folded film 512, are then further processing as desired, such as by sealing of the folded film 512 at longitudinal and cross-sections, and cutting at seals.

Once a dough composition (e.g., dough piece) has been subjected to at least one processing step, as may be aided by the presence of the heat stable film, the heat stable film may be caused to form at least a portion of a package for the dough product. That is, the heat stable film may be a part or a component of a package, such as a final package of a dough product for sale or distribution of the dough product. As an example, the heat stable film may function as one or more layers of a single or multi-layer package used to contain one or more individual dough pieces. Optionally, one or more dough products that include a package that includes the heat-stable film, may be combined in a larger package, in any useful or desired fashion and by use of any other films or packaging components.

In exemplary embodiments of the invention, the heat stable film may constitute an entire component of a final package of a packaged dough product of the invention, such as a one-piece flexible wrapper, tube, chub, pouch, or bag. In general, a heat stable film may be used by itself, absent any other packaging material, to contain one or more dough pieces in a way that surrounds and seals the dough or dough pieces. The packaged dough product, including essentially only a dough piece or pieces contained by a single packaging material, i.e., the sealed or otherwise closed heat stable film, may optionally be in condition for sale in this form, including labeling, marketing information, instructions, etc. Optionally, such a packaged dough product may be further enclosed, alone or in combination with additional dough products in the same packaging, within additional packaging such as a box or bag that encloses multiple individually wrapped dough products of the invention.

In alternate embodiments, the heat stable film can be one of multiple different components of a package. For example, the heat stable film may be a flexible or rigid support for one or more dough pieces (e.g., a flexible or rigid sheet or tray), the support being contained within another packaging material such as a box, bag, pouch, etc. As a more specific example of such an embodiment, a heat stable film may be in the form of a tray that is shaped and sized to contain and support a dough piece or multiple dough pieces and contain the piece or pieces on several sides, with an opening or openings that allow access to the dough piece or pieces. An opening can be covered or closed by use of another piece of packaging material that may or may not be heat stable, such as a flexible film, paper, or cardboard. Alternately, the tray or sheet can be contained completely by another enclosure such as a box, bag, pouch, etc., from which the tray or sheet can be removed and optionally replaced as desired. The package can be opened and the food product may be processed (e.g., optionally heated or cooked) while at least partially contained by the package, or the food can be served or eaten from the package.

Of course, the method used to form the heat stable film into at least a portion of a package will vary according to the type of package formed. Known methods of forming desired packages or portions of packages, as well as methods developed in the future, may be useful, as will be understood. Common packaging steps or methods that may be used include folding, rolling, or otherwise shaping; extruding; placing; orienting; cutting or otherwise sizing; and sealing, as may be accomplished via heat sealing, adhesive placement, or mechanical sealing via clips, staples, ties, etc. A combination of steps or methods may also be used, if desired.

Optionally, depending on the form and type of dough composition, a package formed according to the present description can be capable of accommodating an increase in dough volume so that a volume of a dough composition contained in a package may increase following packaging, e.g., during refrigerated storage, during a proofing step, or during cooking. Leavened dough products may typically expand upon proofing or baking to volume of 150%, or even 200%, and sometimes as much as 300% of their raw dough volume.

One example of forming the heat stable film into at least a portion of a package may include a step of manipulating the heat stable film to form an enclosure such as a tube or tray that contains a dough composition such as an amount of dough extrudate. The method may also involve forming a seal along at edges of the length or ends of a tube. The heat stable film may also be sized (lengthwise), and the ends sealed by adhesive, mechanical, or heat sealing means to enclose the dough product. The tube or other enclosure may be sufficiently oversized to accommodate an increase in dough volume upon proofing or baking, if desired. For example, the heat stable film may be of a sufficient lengthwise size to accommodate anticipated leavening of the dough composition during proofing or baking within the package. If the dough composition has not yet been portioned and is provided as a dough extrudate, the step of portioning the dough extrudate into pieces may optionally be combined with sizing and even sealing the heat stable film, if desired. That is, once the heat stable film is caused to form an enclosure for a length of dough extrudate, the step of crimping or cutting the dough extrudate into pieces may also be used to size the heat stable film and may even bring sections of the heat stable film into close enough proximity so that a clip, staple, tie, adhesive seal (e.g., impulse or heat seal), etc., may be placed or formed, thereby forming a seal in the package about the dough product.

Once the heat stable film has been formed into at least a portion of a package of a dough product, the dough product may be further processed, if desired, according to any dough processing steps or combination of steps. For example, a dough product may be subjected to heating temperatures, e.g., to proof, parbake, or bake the dough product, or to cooling temperatures, e.g., to substantially prevent proofing or to refrigerate or freeze the dough product, without removing the heat stable film. As a result, any pan, tray or other container that would otherwise be used to hold the dough product during such processes may be eliminated, or would not require cleaning after use in this fashion.

The methods described herein can be useful in the manufacture of any various types of dough products. As such, the particular types, formulations, and forms (e.g., sizes and shapes) of dough compositions that are processed according to the described methods are not limited. By providing sufficient volume for expansion, the packaged dough product may even be leavened within the package, either chemically, by yeast, or via lamination. Filled dough compositions may be particularly beneficially processed according to the present method, because any fillings, whether sweet or savory, can present manufacturing difficulties, not the least of which being the potential for filling leakage during processing or baking. Also, particularly sticky doughs, whether adhesively or cohesively sticky, such as pizza or biscuit doughs, muffin batter, may also be particularly beneficially manufactured according to the present methods. Sticky doughs, typically those with relatively high moisture content and relatively underdeveloped protein structures, can tend to leave residue on manufacturing equipment that can be difficult or time consuming to remove, and may therefore may be particularly suitable for use with methods of the invention.

In addition to the benefits that can be seen in processing, the heat stable film may also advantageously be subjected to baking temperatures while substantially maintaining its integrity. Of course, if there is a need to accommodate the release of steam or gas during such heating, minor venting may be provided without compromising the ability of the heat stable film to contain the dough product or any filling provided therein. Minor perforations, for example, or other interruptions, may be provided within a sealed region sufficient to allow for any generated steam or gas to be released without substantially compromising the seal integrity.

Any heat stable film capable of being formed into at least a portion of a package may be used in the present method and many such films, also known as “ovenable” or “cook-in” films, are known. Typically, such films are comprised of polymeric materials, including, for example, polyesters such as polyethylene terephthalate, nylon, and the like. A useful film may include a single layer of polymeric material, or multiple layers of various different polymeric materials corresponding to various functions. Examples of multi-layer materials including one or a combination of layers, e.g., co-extruded or laminated layers, which function as, e.g.,: barrier material layers such as an oxygen barrier layer, a carbon dioxide barrier layer, a moisture barrier layer, or one or more layers that perform a combination of these barrier properties; a layer that contains coated or embedded graphics; a layer that contains a chemical scavenger such as a carbon dioxide or an oxygen scavenger; an adhesive layer such as a thermoplastic adhesive layer; or combinations of these and other layers of materials that may be useful in a packaging film as described herein.

Commercially available examples of such films includes those sold under the trade designation Mylar (E.I. du Pont de Nemours, Wilmington Del.), Nylon 6 and Nylon 66 (E.I. du Pont de Nemours, Wilmington Del.), and Milprint Ovenable Film (Milprint, Oshkosh Wis.).

### EXAMPLE

A filled dough product having the following formulation was prepared as follows:

A roll of Milprint Ovenable Film was provided and sized to a width of about 10″. The free end of the film was attached to a stationary conveying apparatus so that, once activated, the conveying apparatus would pull the film to overlie the belt as it moved. Filled dough products were placed onto the film overlying the conveying apparatus. The dough product had an approximate width of from about 0.5″ to about 2 inches. The conveying apparatus was set to move the dough product at a standard line rate. The heat stable film was folded over the dough product. The dough product, now substantially enclosed, was processed using a blunt edged crimp tool that compressed the dough product and pressed portions of the heat stable film into proximity. The dough product was then cut to provide a portioned dough product.

Edges of the heat stable film were then sealed using heat sealing techniques, to provide a portioned dough product totally enclosed within the folded heat stable film. The packaged dough products were then conveyed through an oven, where the dough products were baked at a temperature of from about 425° F. to about 450° F. for 7-14 minutes.

The resulting baked dough products had risen as desired, even without a proofing step, to achieve a satisfactory bread-like crumb and texture. Further, the dough products also browned sufficiently to be visually pleasing. No filling leakage outside of the heat stable film was apparent, and in fact, only sporadic and minimal filling leakage occurred out of the filled dough product into the heat stable film. Such a product could be frozen in the package, stored frozen, removed and re-heated in a microwave while in the package, and then eaten “on-the-go” directly from the package.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A method of manufacturing a packaged dough product, the method comprising
supplying a dough product and a heat stable film operatively disposed relative to one another;
performing at least one processing step on the operatively disposed dough product and heat stable film; and
causing the heat stable film to form at least a portion of a package about the dough product, to provide a packaged dough product.

2. The method of claim 1 wherein the step of providing the dough product comprises extruding the dough product.

3. The method of claim 1 comprising
extruding the dough product onto the heat stable film while the heat stable film is being conveyed, and
folding the heat stable film about the dough product.

4. The method of claim 1 wherein
the heat stable film is placed onto a conveyor from a supply of heat stable film,
the heat stable film is conveyed along the conveyor, and
a dough product is placed on the heat stable film while the heat stable film is being conveyed.

5. The method of claim 4 wherein
the heat stable film is placed onto a conveyor from a supply of heat stable film,
the heat stable film is conveyed along the conveyor, and
a dough product is extruded onto the heat stable film while the heat stable film is being conveyed to produce a continuous extrudate on the heat stable film.

6. The method of claim 4 wherein
the heat stable film is placed onto a conveyor from a supply of heat stable film,
the heat stable film is conveyed along the conveyor,
a dough product is extruded onto the heat stable film while the heat stable film is being conveyed to produce a continuous extrudate on the heat stable film, and
a second heat stable film is placed on top of the continuous extrudate on the heat stable film.

7. The method of claim 4 wherein
the heat stable film is placed onto a conveyor from a supply of heat stable film,
the heat stable film is conveyed along the conveyor,
a dough product is extruded onto the heat stable film while the heat stable film is being conveyed, to produce a continuous extrudate,
the heat stable film is folded to at least partially enclose the extruded dough product.

8. The method of claim 4 wherein
the heat stable film is placed onto a conveyor from a supply of heat stable film,
the heat stable film is conveyed along the conveyor,
a dough product is extruded onto the heat stable film while the heat stable film is being conveyed, to produce a continuous extrudate,
the heat stable film is folded to at least partially enclose the extruded dough product to produce a continuous extrudate at least partially enclosed by the folded heat stable film, and
cutting the continuous extrudate at least partially enclosed by the folded heat stable film.

9. The method of claim 1 wherein the heat stable film is selected from the group consisting of polyethylene terephthalate, nylon, and combinations thereof.

10. A method of manufacturing a packaged dough product, the method comprising
providing a raw dough product,
providing a heat stable film,
placing the raw dough product on a surface of the heat stable film such that the raw dough product is supported by the heat stable film;
performing at least one processing step on the dough product; and
causing the heat stable film to form at least a portion of a package about the dough product, to provide a packaged dough product.

11. The method of claim 10 wherein the portion of package is a flexible film.

12. The method of claim 10 wherein the heat stable film is selected from the group consisting of polyethylene terephthalate, nylon, and combinations thereof.

13. The method of claim 10 wherein the heat stable film comprises a polyester.

14. The method of claim 10 comprising heating the package.

15. The method of claim 10 comprising allowing the dough composition to expand within the package.

16. The method of claim 10 wherein the portion of package is a portion of a final dough product package.

17. A packaged dough product made according to the method of claim 1.

18. A packaged dough product made according to the method of claim 10.
